(19) United States
(12) Patent Application Publication
(10) Pub. No.: US 2007/0264620 A1
(43) Pub. Date: Nov. 15, 2007

(54) TESTING SYSTEMS AND METHODS USING MANUFACTURING SIMULATIONS

(75) Inventors: Paul Allen Maddix, Sadieville, KY (US); Kenneth Hatch, Georgetown, KY (US); Charles Cloughly, Georgetown, KY (US)

Correspondence Address: DINSMORE & SHOHL, LLP, 1900 CHEMED CENTER, 255 EAST FIFTH STREET, CINCINNATI, OH, 45202, US

(73) Assignee: Toyota Motor Engineering & Manufacturing North America, Inc., Erlanger, KY (US)

(21) Appl. No.: 11/678,307

(22) Filed: Feb. 23, 2007

Related U.S. Application Data
(60) Provisional application No. 60/776,599, filed on Feb. 24, 2006.
(60) Provisional application No. 60/784,175, filed on Mar. 21, 2006.

(51) Int. Cl. G09B 19/00

(52) U.S. Cl. 434/219

(57) ABSTRACT

A testing system configured to test a person's performance at manufacturing related tasks comprises at least one simulated workstation in one embodiment. Each simulated workstation is modeled after a manufacturing related task and comprises at least one work piece to which the task is to be conducted, and at least one detector associated with the work piece. The detector is operable to detect a manufacturing task performed by a person and is configured to generate a signal based upon on the performance. The simulated workstation further comprises at least one instructional device configured to inform a person of the tasks to be performed on the work piece at the workstation, and at least one automated electronic scoring mechanism configured to receive the signal from the detector and tabulate a person's performance at the task.

### CROSS REFERENCE TO RELATED APPLICATIONS

This application claims the benefit of U.S. Provisional Application Ser. Nos. 60/776,599 (22562.42), filed Feb. 24, 2006, and 60/784,175 (22562.42A), filed Mar. 21, 2006, the entire disclosures of which are incorporated herein by reference.

### FIELD OF THE INVENTION

This invention relates to systems and methods for testing a person's aptitude at manufacturing related tasks, and particularly to automated systems and methods used in testing a person's aptitude at automotive manufacturing related tasks.

### BACKGROUND OF THE INVENTION

In a general sense, or specifically in a manufacturing setting, employers continuously strive to improve the testing and selection processes of potential employees as well as the training processes of employees. In hiring at manufacturing facilities, employers want to ascertain a potential employee's competence at manufacturing related tasks in general, as well as the specific tasks in which the potential employee demonstrates proficiency.

This enables an employee to be placed in a job that he/she is more adept, thereby providing several benefits. First, it increases the job satisfaction of the employee. An employee, who is ill suited for an assigned job, may become frustrated and dissatisfied with the job. Second, hiring employees to suitable jobs increases job satisfaction and leads to increased retention of employees. Third, the productivity of the company increases because employees are more productive and efficient when placed properly in a job.

Despite these advantages of testing and determining job competence prior to hiring, carrying out such testing remains challenging, because it is difficult to create testing systems that accurately gauge a potential employee's skills in the desired working environment. Moreover, it can be difficult and time consuming to implement and carry out such testing. As manufacturing demands increase, the need arises for improved systems and methods effective at testing a person's aptitude at manufacturing related tasks.

### SUMMARY OF THE INVENTION

In a first embodiment, a testing system configured to test a person's performance at manufacturing related tasks is provided. The testing system comprises at least one simulated workstation, wherein each workstation is modeled after a manufacturing related task. The simulated workstation comprises at least one work piece to which the task is to be conducted, and at least one detector associated with the work piece. The detector is operable to detect a manufacturing task performed by a person and is configured to generate a signal based upon the performance. The simulated workstation further comprises at least one instructional device configured to inform a person of the tasks to be performed on the work piece at the workstation, and at least one automated electronic scoring mechanism configured to receive the signal from the detector and tabulate a person's performance at the task.

In a second embodiment, a work evaluation method is provided. The work evaluation method comprises providing at least one simulated workstation configured to inform one or more persons of a manufacturing task to be performed at the workstation and to automatically score the person's performance at the task. The work evaluation method further comprises receiving score data from the simulated workstation on the persons' performance at the manufacturing task, producing a work profile for each person from the score data, providing at least one job profile comprising performance criteria required for a specific job, and ascertaining whether the person's work profile substantially matches the performance criteria of the job profiles.

In a third embodiment, a multi-task work evaluation method is provided. The method comprises providing a manufacturing related task to be performed by a person at a simulated workstation, recording the person's performance of the task at the simulated workstation via an automated electronic scoring mechanism, and generating automatically, based on a person's performance at a manufacturing related task, at least one additional task to be performed by the person at the simulated workstation. In a third embodiment, another work evaluation method is provided. The work evaluation method comprises receiving signals from a plurality of detectors, wherein the detectors may be triggered by a person performing a manufacturing related task at a simulated workstation. The performance may be recorded by comparing the timing of the detector signals to an expected timing of detector signals, and evaluating the person's performance based upon the comparison.

Additional features and advantages provided by the embodiments of the testing systems and work evaluation methods of the present invention will be more fully understood in view of the following detailed description, in conjunction with the drawings.

### BRIEF DESCRIPTION OF THE DRAWINGS

The following detailed description of specific illustrative embodiments of the present invention can be best understood when read in conjunction with the following drawings, where like structure is indicated with like reference numerals and in which:

FIG. 1a is a schematic view illustrating a testing system according to one or more embodiments of the present invention;

FIG. 1b is a flow chart illustrating an example of the operation of a testing system according to one or more embodiments of the present invention;

FIG. 2a is a schematic view of an example of a simulated workstation configured to test a person's performance at bolt insertion and/or removal according to one or more embodiments of the present invention;

FIG. 2b is a cross sectional schematic view of an example of a bolt module used in the simulated workstation of FIG. 2a according to one or more embodiments of the present invention;

FIG. 3 is a schematic view of an example of a simulated workstation configured to test a person's performance at wire harness connection and/or disconnection according to one or more embodiments of the present invention;

FIG. 4a is a schematic view of an example of a simulated workstation configured to test a person's performance at welding according to one or more embodiments of the present invention;

FIG. 4b is a schematic view of an example of a welding module used in the simulated workstation of FIG. 4a according to one or more embodiments of the present invention;

FIG. 5 is a schematic view of an example of a simulated workstation configured to test a person's performance at handling weights of various sizes according to one or more embodiments of the present invention; and

FIG. 6 is a schematic view of an example of a simulated workstation configured to test a person's performance at painting according to one or more embodiments of the present invention.

### DETAILED DESCRIPTION OF ILLUSTRATIVE EMBODIMENTS

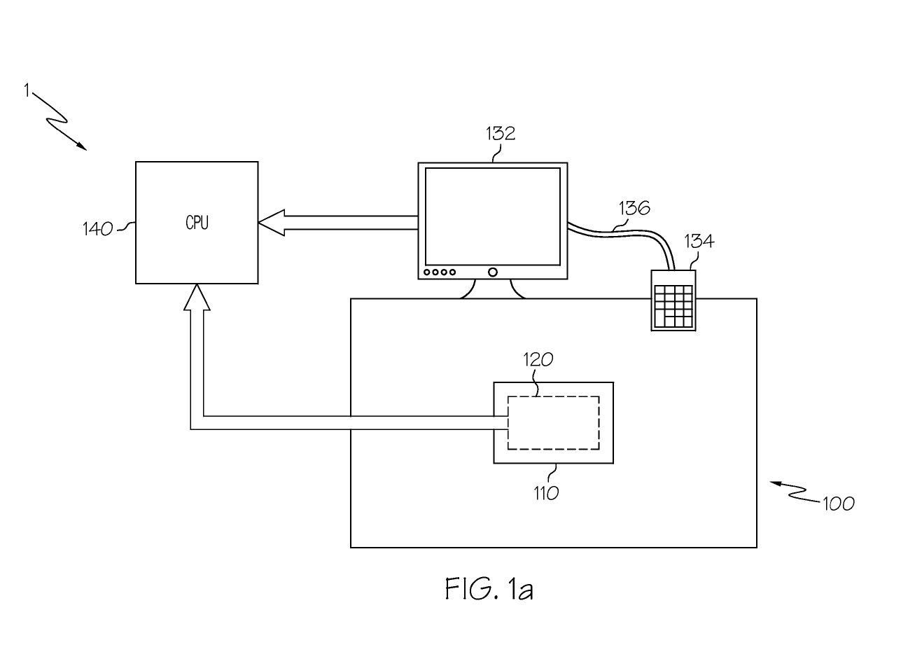

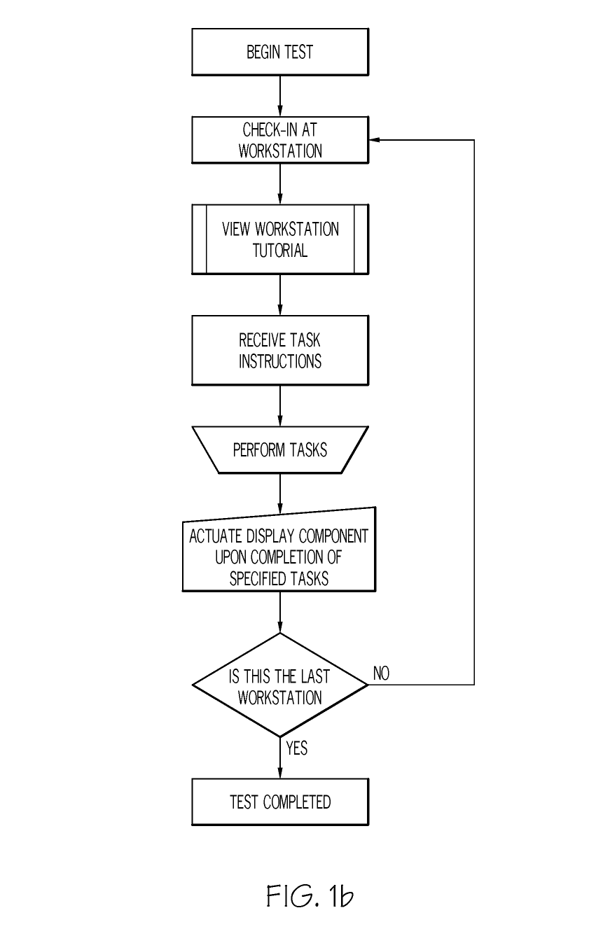

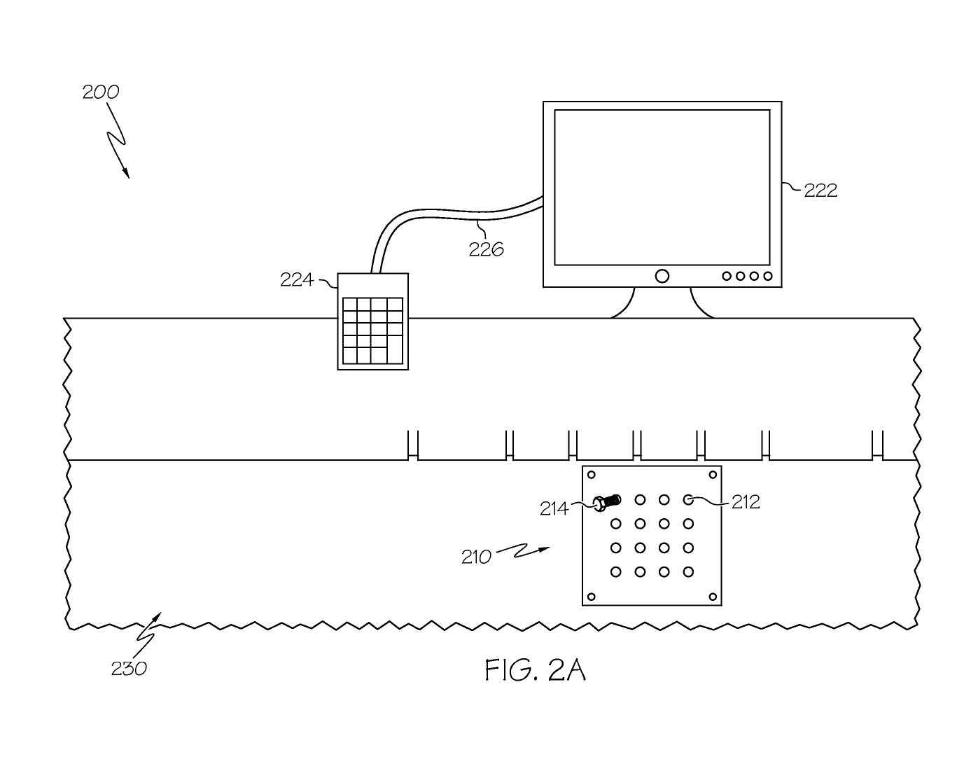

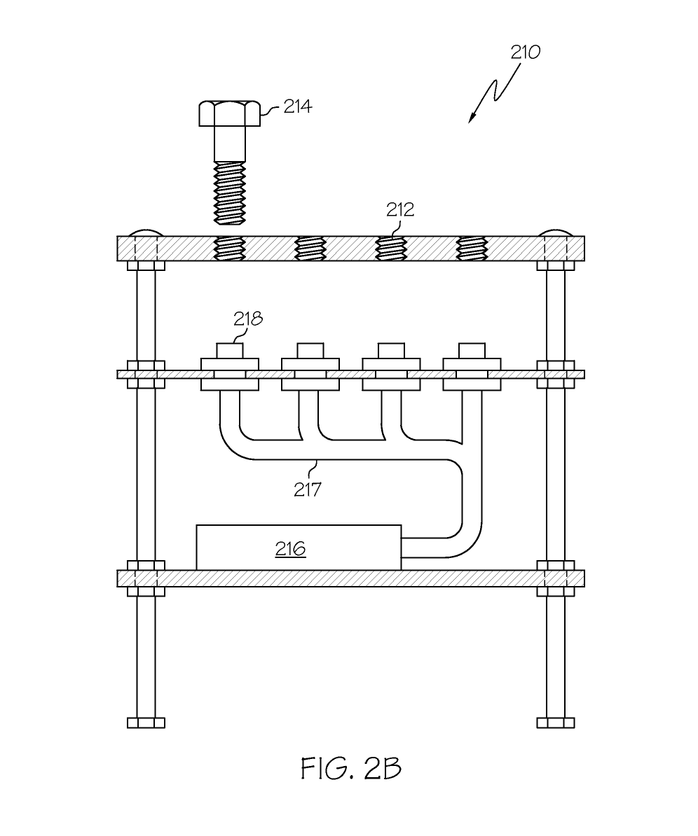

Referring to FIG. 1a, an example of a testing system 1 configured to test a person's performance at manufacturing related tasks is shown. The testing system 1 comprises at least one simulated workstation 100 modeled after a manufacturing related task. In one embodiment, the simulated workstations 100 may be modeled after automotive manufacturing related tasks. Referring generally to several embodiments as shown in FIGS. 2-6, the manufacturing tasks may test a person's aptitude at bolt insertion and/or removal, at wire harness connection and/or disconnection, at welding, at painting, at handling weights of various sizes, or combinations thereof. Other manufacturing tasks, for example, assembling an engine, a transmission, a braking system, or other automotive components, are contemplated herein.

Referring to FIG. 1b, the testing system may comprise multiple workstations designed to determine the test taker's skills at a variety of manufacturing related tasks. In some embodiments, the testing system may require completion of all tasks at a workstation, before a test taker may move onto another workstation. Alternatively, the testing system may stagger the manufacturing tasks. In this staggered embodiment, the test taker would complete a portion of the required tasks at a first workstation, move onto other workstations, and subsequently return to complete the remaining required tasks at the first workstation. In a further embodiment, the workstations 100 may be configured to test one or more persons at a workstation simultaneously. When multiple persons are being tested at a simulated workstation, each person may, in one embodiment, all receive different tasks and/or task sequences. Furthermore, when multiple persons are tested at the same work station 100, the testing system may be configured to allow or disallow one candidate's actions to impact another candidate's actions.

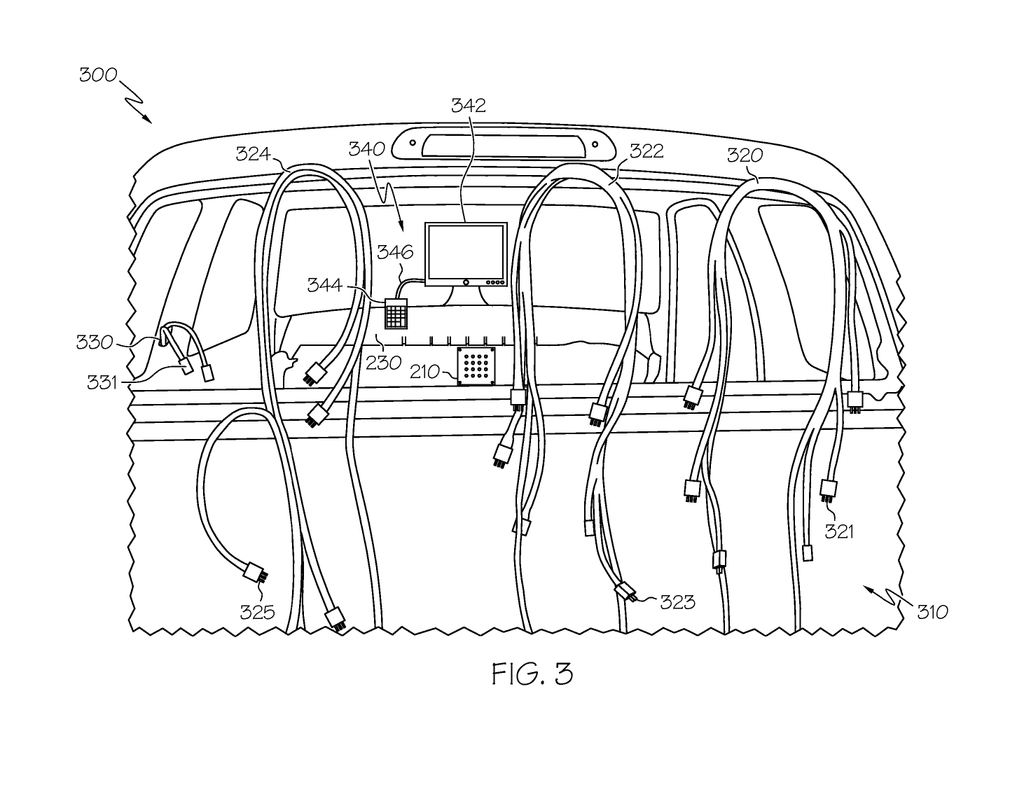

Referring to FIG. 1a, the simulated workstation 100 comprises at least one work piece 110 to which the manufacturing task is to be conducted. In many embodiments, multiple work pieces may be disposed at a workstation to facilitate more rigorous testing. Referring to the embodiments of FIGS. 2-6, the work piece 110 may comprise components associated with bolt insertion and/or removal, wire harness connection and/or disconnection, welding, painting, and handling weights. The work piece 110 may also comprise other manufacturing related work pieces, for example, work pieces used in automotive manufacture, as would be familiar to one skilled in the art. Moreover, work pieces associated with separate manufacturing tasks may share the same workstation. In one embodiment as shown in FIG. 3, the bolt module work piece 210 and the work pieces associated with the wire harness share the same simulated workstation 300.

Referring to FIG. 1a, the workstation 100 also comprises at least one detector 120 associated with the work piece 110. The detector 120 is triggered by the performance of a manufacturing task, and is configured to generate a signal based upon the performance. As defined herein, the detector 120 may comprise any suitable device that is triggered by a user action, and responds by generating a signal. A signal, as defined herein, may comprise any data, a visual image, an audio stream, an electric signal, an electronic signal, a radio frequency signal, or any other signal types known to one skilled in the art. In one embodiment, the detector 120 may comprise an imaging device configured to provide image data representing the work piece 110, wherein the image data constitutes the signal. In an exemplary embodiment, the imaging device comprises a camera, e.g., a digital camera, coupled to the simulated workstation. In yet another exemplary embodiment, the camera is a network digital camera operable to continually shoot images at variable speeds, or is operable to take single shots. In another embodiment, the detector 120 comprises a sensor 120. In some exemplary embodiments, the sensor 120 comprises a switch configured to open or close a circuit upon actuation, a magnetic switch, a touch sensor, a weight sensor, a motion sensor, a contact switch, relay, proximity switch, position detector, or combinations thereof. Other sensor types known to one skilled in the art are contemplated herein. The sensor 120 may be visible or embedded in the work piece as shown in FIG. 1a. In a further embodiment, the simulated workstation may comprise multiple detector types. For example, the testing system 1 may comprise a sensor, as well as a digital camera for use as detectors.

Referring to FIG. 1a, the workstation 100 also comprises at least one instructional device 132 configured to inform a person of the tasks to be performed at the workstation 100. For example, the instructional device 132 may specify a slot for a bolt to be inserted. In a further embodiment, the instructional device 132 may also provide a tutorial to the user that shows the proper procedures for performing a manufacturing task. For example, the tutorial may instruct a person to bend at the knees when engaged in a weight handling exercise, or may show a user the proper way to tighten bolts using an air gun. The instructional device 132 may comprise various components known to one skilled in the art. In some exemplary embodiments, the instructional device 132 may comprise a display monitor 132, an audio component, an instruction document, or combinations thereof. The instructional device 132 may be used to provide instructions for one or multiple workstations. In an exemplary embodiment, two or more adjacent workstations could share the same instructional device, wherein the instructional device would be configured to provide a tutorial and/or a set of task instructions for both workstations.

In a further embodiment as shown in FIG. 1a, the testing system 1 may comprise a user control component 134 configured to allow the test taker to control the instructional device 132. The test taker may actuate the user control component 134 to trigger the instructional device 132 to provide the next task in a sequence of instructions, or to indicate the completion of a sequence of tasks. Referring to the embodiment of FIG. 1a, the user control component 134 comprises a keypad 134 configured to control a display monitor 132; however, other user control components and combinations of user control components are contemplated herein. For example, if the instructional device 132 comprises an audio component, such as a stereo, the user control component may comprise the buttons and/or knobs on the stereo face. As shown in the embodiment of FIG. 1a, the display monitor 132 is coupled to the keypad 134 via a power cord 136; however, other connection means, such as a wireless connection, is also contemplated. In a wireless embodiment, the user control component would essentially act as a remote control device.

Referring to FIG. 1a, the simulated workstation 100 comprises at least one automated electronic scoring mechanism 140 configured to receive the signal from the detector 120 and tabulate a person's performance at the task. In one embodiment, the automated electronic scoring mechanism 140 comprises any suitable device operable to compile the detector signals into at least one score for the test taker. In some embodiments, the automated electronic scoring mechanism 140 comprises a microprocessor and/or a computer. In a further embodiment, the automated electronic scoring mechanism 140 comprises software designed to tabulate the scores of the person performing the tasks.

In a further embodiment of the present invention, the testing system may also comprise at least one signal converter operable to translate a detected signal by the detector into a usable format for the automated scoring mechanism. For example, an I/O module may be used for this purpose. As described above, numerous detector types, such as a digital camera or a sensor, are possible. Referring to an apparatus embodiment of the bolt insertion module 210 as shown in FIG. 2b, the signal converter 216 is connected to detectors, e.g. on/off contact switches 218. When a bolt 214 is inserted a slot 212, the bolt 214 actuates the switch 218, thereby sending a signal, via signal cord 217 or wirelessly, to the signal converter 216. The signal converter 216 translates the signal into a usable format for the automated electronic scoring mechanism, for example, binary 1's and 0's. Other languages formats are contemplated herein. For example, the signal converter may convert a detector signal into RS232 signal for the automated scoring mechanism to process.

In addition to scoring, the automated electronic scoring mechanism 140 may, in some exemplary embodiments, create and/or randomize the tasks performed at a simulated workstation 100. In one exemplary embodiment, the automated scoring mechanism 140 randomizes the tasks, while ensuring fairness. Alternatively, the instructional device 132 may create or randomize the tasks performed at the workstation. For example, two separate test takers may receive different tasks; however, the automated scoring mechanism 140 may ensure that the difficulty level of the tasks is equal. In a further example, it may also ensure that one person is not being “overtested” at one workstation in comparison to another test taker.

In yet another embodiment, the automated electronic scoring mechanism 140 is operable to recalibrate itself based upon a person's performance of a task, and add a new task after calibration. Under this embodiment, the detector registers a test taker's performance and transmits a signal corresponding to the performance to the automated electronic scoring mechanism 140. The automated electronic scoring mechanism 140 is then calibrated to account for the test taker's prior action or performance. After calibration, the automated electronic scoring mechanism 140 generates a new task to be displayed by the instructional device 132, and performed by the test taker. In addition to accounting for the previously performed task, the automated electronic scoring mechanism 140 may, in one embodiment, account for safety procedures to be followed while conducting the tasks at the simulated workstation 100. In essence, the automated scoring mechanism is configured to generate and assign tasks for the test taker to perform while obeying the safety procedures. Recalibrating after the performance of each task prevents delays that would occur with a set sequence of instructions, as the following hypothetical example will illustrate. During testing at a bolt insertion workstation, the display monitor instructs a person to insert a bolt into slot 9 of the grid. However, the person inserts a bolt into slot 8 instead of slot 9 in the grid, as requested. The sensor detects that the bolt as inserted into a slot 8. The next task in the programmed sequence of instructions requires the insertion of a bolt into slot 8, which creates problems, because a bolt is already in that slot. This could delay the test if an assessor/tester has to revise the sequence of tasks. Alternatively, if the new task went ahead and displayed a slot 8 task, the person now knows he/she made a mistake on the previous task, and is now able to correct the mistake, thereby skewing the scoring process. Accordingly, in this embodiment, the automated scoring mechanism 140 modifies the task sequence that it ordinarily would have followed, such that the future tasks do not involve slot 8, or alternatively involve the removal of the bolt from slot 8. Thus, real time modifications and re-calibrations of the testing program are possible after each completed task.

In another embodiment, the automated scoring mechanism 140 may further adjust the difficulty level of the testing system. For instance, the automated scoring mechanism 140 may raise or lower the level of difficulty based on interactions with the test taker. For example, the automated scoring mechanism 140 may gradually increase the speed required to complete a task or may gradually increase the complexity of a task when a test taker is performing well. This may enable the automated scoring mechanism 140 to determine a test taker's maximum performance. Conversely, automated scoring mechanism 140 may also gradually slow a task down or gradually lower the complexity of a set of tasks for a poorly performing test taker. If the timing requirements for a test taker are too difficult, the test taker may rush, thereby resulting in increased mistakes and/or improper safety practices. Slowing down task sequences may ensure better safety practices and accuracy by the test taker, although the efficiency scores of the test taker may be negatively impacted.

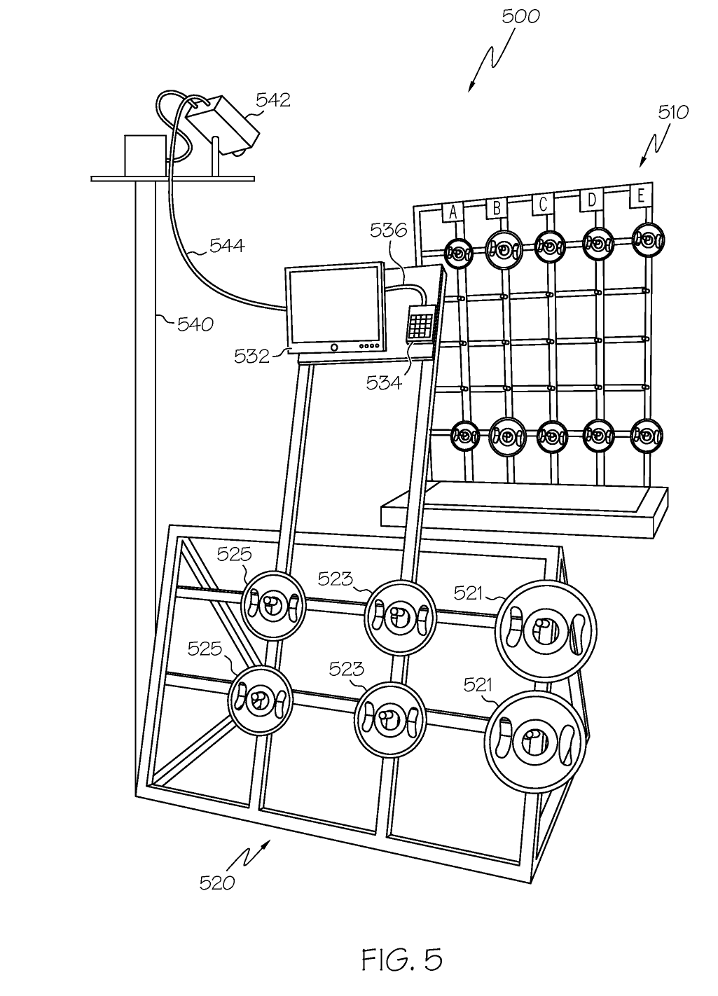

In another embodiment, the automated scoring mechanism 140 may tailor its tasks based on the hiring demands of the production facility. For example, if an employer is hiring for a physically strenuous production job, a testing system focused on determining a test takers' strength and endurance, e.g. the weight mount workstation as shown in FIG. 5, should be utilized. In another embodiment, the automated electronic scoring mechanism 140 is operable to adjust a person's score to correct for malfunctions in the simulated workstation 100. Various malfunctions in a simulated workstation are possible. For example, the malfunction may be due to a corrupted or broken detector 120, e.g., a broken sensor or partial obscured digital camera.

A person's performance at an assigned task may be evaluated based on many factors. In some embodiments, the automated scoring mechanism 140 scores the speed, order, efficiency and/or accuracy of the test taker at the assigned task. The accuracy may be determined by comparing the detector signal representing the performance against the expected detector signal. Similarly, the speed and efficiency of a test taker's performance may be measured by comparing the timing of the detector signals to an expected timing of detector signals. In another embodiment, the automated scoring mechanism 140 may further calculate the time it takes a test taker to complete a single task, multiple tasks, or all workstation tasks, and may also calculate the number of tasks completed in an allotted time period. By recording the completion timing of single and multiple tasks, the automated scoring mechanism may determine the speed of persons at various stages. Additionally, by scoring multiple tasks, the automated electronic scoring mechanism 140 can determine if and when a person gets fatigued during the performance of tasks at a simulated workstation 100, due to the timing, speed, and physical and/or mental exertion of the tasks. In yet another embodiment, the automated electronic scoring mechanism 140 calculates the number of tasks completed in an allotted time period to determine a person's efficiency at a simulated workstation 100.

In a further embodiment, the automated scoring mechanism 140 may score a test taker based on his/her utilization of proper procedures and safety practices, while performing the tasks. In yet another embodiment, the automated scoring mechanism 140 may also evaluate a person's health factors, while performing the tasks. For example, an employer may want to determine a person's stamina or endurance when engaged in physically strenuous manufacturing tasks, such as weight handling. Physiological monitors can be utilized in such embodiments, such as heart rate, temperature, blood pressure, or other monitor types.

Moreover, the automated electronic scoring mechanism 140 may score a person using a variety of grading standards. Each test taker may receive a score for each simulated workstation and/or a total score of all the workstations. Any grading type, for example, number or letter grading is contemplated herein. In one embodiment, the automated electronic scoring mechanism 140 is operable to score a test taker's performance against a sample or a partial sample of all test takers. This sample may be defined in multiple ways, including but not limited to, a sample of worldwide candidates, a sample of national candidates, a sample of regional candidates (i.e. East, Midwest, etc), a sample of statewide candidates, or a sample of candidates at the respective manufacturing facility. Moreover, a test taker's performance may be ranked, evaluated against a benchmark, or scored in terms of percentile. Furthermore, the data may be aggregated based on demographics as permitted or required by the laws governing the local assessment. In another exemplary embodiment, candidates may be evaluated against other candidates being considered for the same position. Since the order of tasks is randomized and also impacted by applicant performance at prior tasks, the automated electronic scoring mechanism 140 adjusts each candidate, so the comparison of all candidates in the selected sample is fair.

In a further embodiment, the automated electronic scoring mechanism 140 may produce a work profile based on the scores of the person's performance. The work profile may quantify and describe the test taker's performance at specific workstations, and/or in the testing system 1 as a whole. In one embodiment, the work profile may be stored in the memory of the automated scoring mechanism 140. The automated electronic scoring mechanism 140 may further provide at least one job profile comprising performance criteria required for a specific job. The job profile lists desired skills and/or characteristics necessary for a potential employee to be successful at a specific job. By comparing the test taker's work profile against the job profile, the automated scoring mechanism 140 may ascertain which persons are suitable for the manufacturing task in general, and for specific tasks in particular. In a further embodiment, a person, whose profile substantially matches the performance criteria set forth in the job profile, may be provided with an offer of employment. In the system's determination whether an offer should be extended, the testing system may incorporate other evaluation techniques e.g. resume evaluation, interview evaluation, other computer based assessment, and other techniques known to one of ordinary skill in the art.

This embodiment of the automated scoring mechanism can provide various benefits. First, the automated scoring eliminates the need for personnel to score the testing. Second, automated scoring also reduces the amount of personnel needed to supervise the testing. Third, the automated scoring enables the workstation to more accurately simulate the working conditions at a manufacturing facility. Manual scoring produces downtime during the testing, because the scorer must grade each task, or groups of tasks before a person may move onto the next task, or next group of tasks. In contrast, the automated scoring records the test taker's performance continuously, thus allowing the test taker to work without downtime. Consequently, the automated scoring mechanism 140 allows for a better simulation of a manufacturing facility, because manufacturing facilities strive to maximize efficiency and minimize downtime.

Another advantage over manual processes is the ability to defend and audit the testing system. The system 140 keeps detailed transcripts of the actions of the candidates allowing for independent evaluation by testing assessors at any point during or after the testing has been completed. These transcripts may be archived by the system for later review. Similarly, the effectiveness of the system can be measured by evaluating these archived transcripts, thereby facilitating continuous monitoring and improvement of the system. Another related advantage is that these archived transcripts enables an assessor to empirically measure the impact of changing components in the system, for example, changing the vendor of the bolts or what lubricant is used in the air guns.

Additionally, the objective nature of the automated scoring and testing eliminates arguments that a tester was not fair or that the testing and/or scoring was too subjective. Although the system typically evaluates candidates based on performance alone, the system may be configured to consider applicant's personal characteristics, especially when these personal characteristics impact a candidate's suitability for a position. For example, a person with red/green color blindness cannot be a Navy fighter pilot, or work in Intelligence, thus the testing system would have to take this into account.

FIGS. 2-6 provide several embodiments of simulated workstations in accordance with the present invention. Although these embodiments cite specific components of the workstations, additional components or substitute components described above are possible. Referring to the embodiment of FIG. 2a, a simulated workstation 200 modeled after the manufacturing task of bolt insertion and/or removal is provided. In one embodiment, the simulated workstation 200 may comprise a simulated or actual automobile 200. The simulated workstation 200 comprises one or more bolt modules 210 mounted to a support structure 230. To simulate a manufacturing facility environment, the support structure 230, in one embodiment, comprises the front seat 230 of the simulated or actual automobile 200. The bolt module 210 is a grid structure comprising a plurality of slots 212 in which a bolt 214 may be inserted. In one embodiment, the slots 214 may comprise a unique label, for example, a number, a color, and/or a letter, so that a person may know the correct slot for bolt insertion or removal. The workstation 200 also comprises a display monitor 222, and a keypad 224 coupled to the display monitor via a power cord 226. The display monitor 222 instructs the person of the placement and the sequence of placement of the bolts. In one embodiment as shown in FIG. 2b, the slots 212 comprise detectors 218, for example, on/off control switches, which produce a signal in response to a bolt 214 being inserted into a slot 212. The detector signals are sent to an automated scoring mechanism (not shown in FIG. 2a) for tabulation of the test taker's score at the workstation 200. The detectors 218 may be triggered upon partial insertion of a bolt 214 into a slot 212, or insertion of a bolt 214 until flush with the face of the bolt module 210. The bolts 214 and slots 212 may comprise multiple sizes, and dimensions as would be familiar to one skilled in the art. In one embodiment, the detector 218 may inform to the user that the correct bolt 214 has been inserted into the correct slot 212 via an audio response. For example, when the bolt 214 is inserted in the slot 212 and contacts the detector 218, the detector may produce a “locking” or “clicking” sound. In contrast, no audio response may indicate the wrong bolt 214 or slot 212 has been utilized. The workstation 200 may also comprise multiple tools for inserting or removing the bolts 214. These tools may include, but are not limited to, a socket wrench, or an air gun.

Referring to the embodiment of FIG. 3, a simulated workstation 300 modeled after the manufacturing task of wire harness connection and/or disconnection is provided. Similar to above, the simulated workstation 300 may, in one embodiment, comprise a simulated or actual automobile 300. The simulated workstation 300 comprises one or more wire harnesses 320, 322, and 324 removably coupled to a support structure 310. In one embodiment, the wire harnesses may be hung on hooks (not shown) located on the support structure, e.g. the rear cab 310 of a simulated or actual automobile 300. In one embodiment, the test taker removes one or all of the wire harnesses from the back seat 310 of the simulated or actual automobile 310 and moves to the front seat 340 to connect one or more of the wire harness to one or more of the interior female connectors 330. While being connected to the female connectors 330, the wire harnesses may be attached to hooks (not shown) in the front seat 230 of the simulated or actual automobile 300. The wire harnesses 320, 322, and 324 are male connectors comprising various prong configurations. The wire harness prongs 321, 323, and 325 may comprise grounded 6 pin connectors, 3 pin connectors, 2 pin connectors, or any other connector known to one skilled in the art. The wire harnesses 320, 322, and 324 may comprise different colors or patterns to differentiate themselves, so that the test taker will know which wire to use. Moreover, the wire harnesses 320, 322, and 324, and the interior connectors 330 may both comprise labels so the test taker knows the wire harnesses and interior connectors to be joined. Unlimited color possibilities and pin configurations are contemplated herein. The wire harness workstation 300 comprises a display monitor 342, and a keypad 344 coupled to the display monitor 342 via a power cord 346. The display monitor 342 informs the user of the required connection tasks, and the sequence of the connection tasks.

In one embodiment, the female connector 330 comprises detectors (not shown), which are triggered by a wire harness being connected to the female connector 330. The detector signals are sent to an automated scoring mechanism (not shown in FIG. 3) for tabulation of the test taker's score at the workstation 300. In one exemplary embodiment, wherein a 6 pin wire harness embodiment is used, at least one of the pins of the wire harness comprises sensor leads. The number of sensor lead pins provided in a given male harness can be dependent on the color of the harness. For example, a black harness could have two sensor lead pins, and a white harness one sensor lead pin. When the wire harness is connected to the female connector 330, the detectors of the female connector can determine the color of the wire harness based on the number of sensor leads shorted. For example, if two sensor leads of the wire harness are shorted, than the automated scoring mechanism 140 knows the wire harness is black. If one sensor lead is shorted, than the automated scoring mechanism 140 knows the wire harness is white. The sensor leads may correspond to other wire harness colors, and it is also contemplated that the sensor leads may be programmed to indicate other types of information about the harness in addition to color.

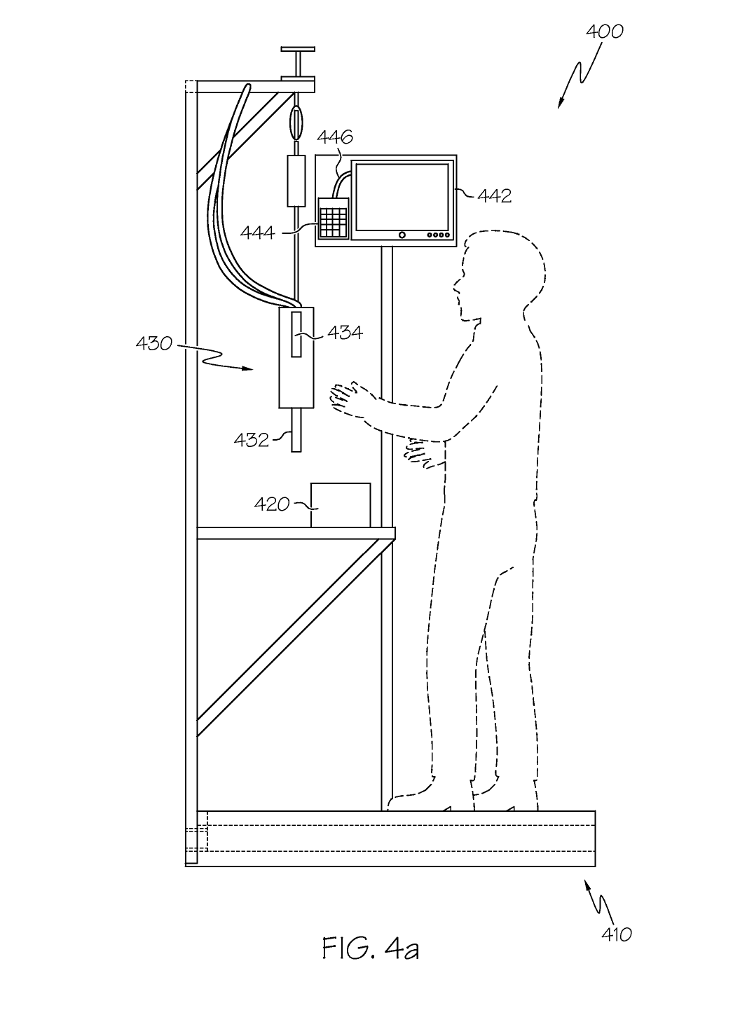

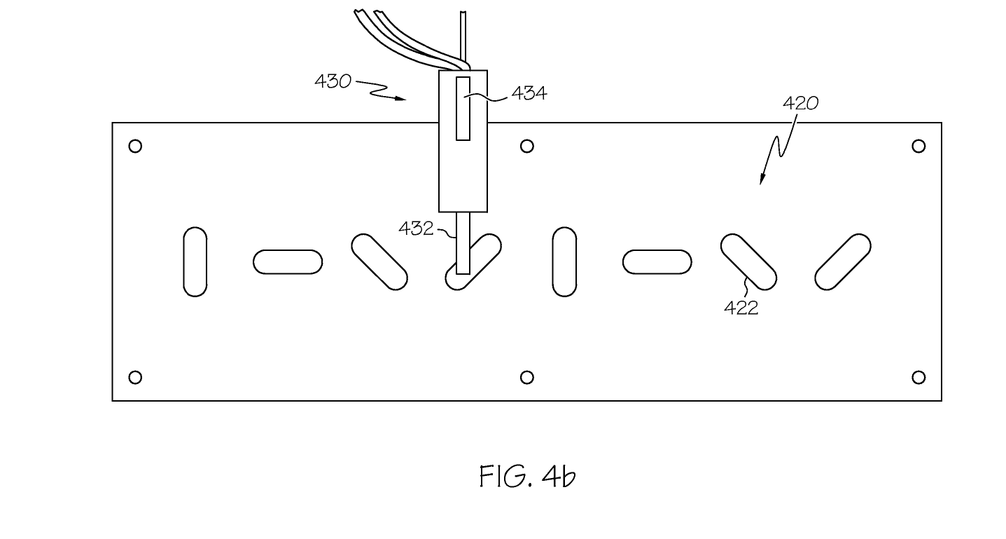

Referring to FIGS. 4a and 4b, a simulated workstation 400 modeled after the manufacturing task of welding is provided. In this embodiment, the simulated workstation 400 comprises at least one welding module 420 having various patterned openings 422 therein. The welding module 420 and the patterned openings 422 are all separately labeled with a numerical and/or an alphabetical designation. The welding modules 420 may be mounted to a support structure, for example, a platform 410 as shown in FIG. 4a. In one embodiment, the simulated workstation 400 comprises a welding tool 430 having a weld nozzle or tang 432, and a handle portion 434. The handle portion 434 may be located on one or more sides of the welding tool 430. The weld workstation 400 also comprises a display monitor 442, and a keypad 444 coupled to the display monitor via a power cord 446. The display monitor 442 provides instructions on which patterned opening 422 the tang 432 of the welding tool 430 should be inserted. In one embodiment, the weld openings 442 comprise detectors (not shown), which are triggered by the tang 432 being inserted into the openings 422. The detector signals are sent to an automated scoring mechanism (not shown in FIG. 4) for tabulation of the test taker's score at the workstation 400. In a further embodiment, the weld module 430 produces an audio response, e.g., an alarm or clicking sound, when the tang 432 is properly inserted into an opening 422.

Referring to FIG. 5, a simulated workstation 500 modeled after the manufacturing task of handling weights and correctly moving the weight from one place to another is provided. For example, simulated workstation 500 may be modeled on the tasks of stocking the parts of an assembly line, or loading the correct parts in the right order on a machine configured to perform work on these parts. The simulated workstation 500 comprises a weight stack 520, and a weight grid 510. The weight stack 520 comprises weights of varying heaviness and size 521, 523, and 525. In one embodiment, the weights 521, 523, and 525 are 10, 20, and 25-pound weights, respectively. The workstation 500 comprises a weight grid 510 comprising a plurality of pegs 512 used to hold weights. The weights 521, 523, and 525 and the pegs 512 may comprise unique labels, for example, number, letter, shape, or color designations. During performance of the tasks, the test taker moves a weight from the weight stack 520 to a specified peg 512 of the weight grid 510. Alternatively, the tasks may also include, but are not limited to, moving a weight from one peg 512 on the grid to another, or moving a weight from the weight grid 510 to the weight stack 520. The workstation 500 also comprises a display monitor 532, and a keypad 534 coupled to the display monitor via a power cord 536. The display monitor 532 informs the person what weight should be moved to which peg 512.

The workstation 500 further comprises a detector. In one embodiment, the detector is a camera 542 mounted on a stand 540 configured to image the person's performance at the workstation 500. These images are sent to an automated scoring mechanism (not shown in FIG. 5) for tabulation of the test taker's score at the workstation 500. The camera 542 may be connected to the display monitor 532 by a power cord 544. For example, and not by way of limitation, the detector may also be a sensor, for example, a weight or a touch sensor, disposed on the pegs 512 of the weight grid 510. In yet another exemplary embodiment, the detector may comprise a radio frequency identification (RFID) reader configured to detect RFID tags attached to one or more of the weights.

In a further embodiment, the weights comprise multiple colors, which the camera 542 uses to detect the person's performance at the workstation 500. By capturing the weight color, the automated electronic scoring mechanism may determine the location of the weight on the grid 510. To locate the weight on the weight grid, the automated scoring mechanism may use various mapping and mathematical approximation methods. Because a camera is utilized, these approximations may need to correct for the angle and position of the camera 542 in relation to the weight grid 510. The approximation may also need to accommodate for other factors, such as the lens, the focal length of the camera lens, and/or the ambient light condition resulting from the location of the workstation 500.

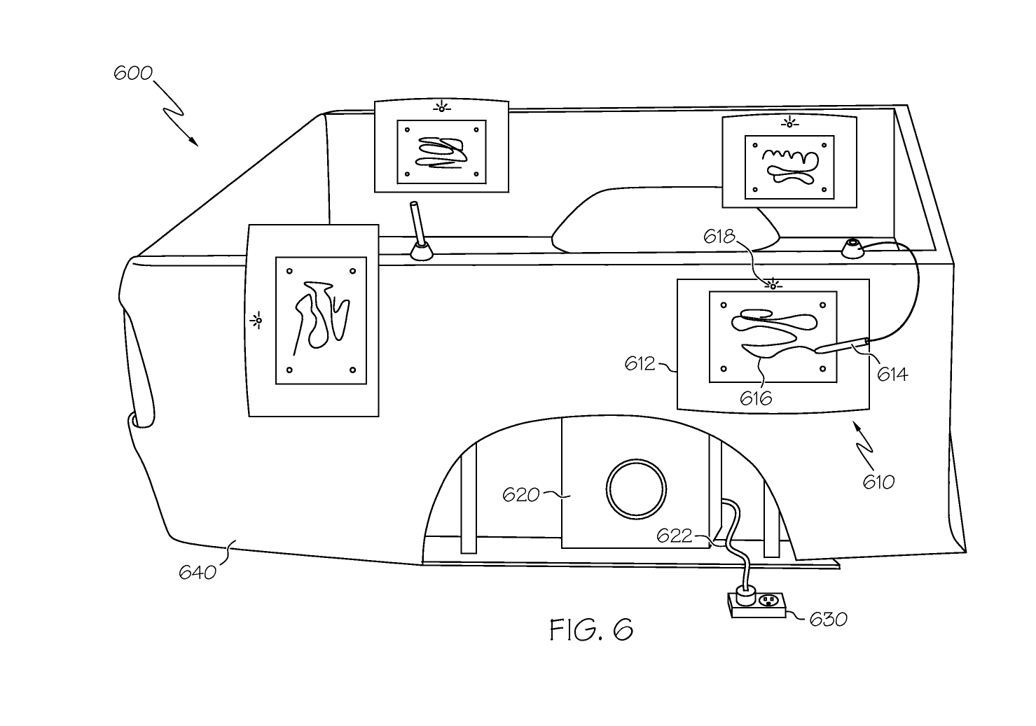

Referring to FIG. 6, a simulated workstation 600 modeled after the manufacturing task of painting is provided. In one embodiment, the simulated workstation 600 comprises a simulated or actual automobile, e.g. a truck bed 640. The simulated workstation 600 comprises at least one tracing assembly 610. The tracing assembly 610 comprises a tracing pad 612 having a plurality of possible tracing patterns 616 thereon, and an attached stylus pen 614. The tracing pattern 616 comprises a track of variable width. To perform the task, the test taker must run the stylus 614 along the tracing pattern 616, while staying inside the tracks of the pattern and as close to the center of the track as possible. The tracing pad 612, e.g. a touch sensitive pad, comprises a detector (not shown) that generates a signal based on the movement of the stylus 614 on the tracing pad 612. The detector signals are sent to an automated scoring mechanism 620, which is coupled to the tracing assembly, for tabulation of the test taker's score at the workstation 600. In one embodiment, the automated scoring mechanism 620 comprises at least one computer 620, which is connected to an electric socket 630 via power cord 622. As shown in FIG. 6, there may be multiple tracing assemblies 610 comprising different patterns 616, wherein each pattern 616 may constitute a different task for the person to complete. In another embodiment, the tracing assembly 610 may comprise a light emitting diode (LED) element 618. The LED element 618 is configured to illuminate or change color when the stylus 614 contacts the tracing pad 612.

In addition to the accuracy of the test taker, the automated scoring mechanism 620 is configured to tabulate various score types on the tracing pad 612. In one embodiment, the tracing pad 612 may use spring loaded resistors (not shown) to determine the pressure applied to the pad 612 by the test taker's stylus 614. When the person applies the stylus 614 to the tracing pad, the spring loaded resistors, which are disposed beneath the tracing pattern 616, compress. By determining the amount of compression of the resistors, the automated electronic scoring mechanism 620 may determine the force or pressure applied by the test taker. In other exemplary embodiments, the automated electronic scoring mechanism 620 may evaluate the test taker based on multiple variables, such as body positioning, smoothness of tracing stroke, hand/eye coordination, consistency, efficiency, velocity, etc. The automated scoring mechanism 620 records the location and direction of the stylus and distance of the tracing path produced by the stylus 614 as it moves long the tracing pad 612. By calculating the derivative of the distance, the automated scoring mechanism 620 may calculate the velocity of the test taker at the tracing pad task. By calculating the derivative of the velocity, the automated scoring mechanism 620 may calculate the acceleration of the test taker with the stylus. If the acceleration is approximately zero, that indicates the test taker applies the stylus to the tracing pad smoothly; however, the degree of smoothness may vary greatly between test takers. As a result, the automated scoring mechanism 620 can evaluate smoothness by calculating the standard deviation of the acceleration along the tracing track 616 to determine if the test taker has a smooth or jerky motion. The automated scoring mechanism 620 may also determine when a person removes the stylus from the tracing pad 612. In addition to smoothness, the automated electronic scoring mechanism may determine the consistency of the test taker while performing a task. For example, removing the stylus 614 from the tracing pad 612, while in the middle of a tracing task, indicates a lack of consistency by the test taker that may factor into the score of the employee. Similar to other workstations, the tasks may be timed to determine a test taker's efficiency at completing the tasks. Thus, scoring can take into consideration the test taker's speed, acceleration, and contact of the stylus to measure such attributes as efficiency, coordination, control, agility, smoothness, focus, and fatigue.

Although not shown, the workstation 600 may further comprise an instructional device, or it may share the instructional device of another workstation. In an exemplary embodiment, the workstation 600 may use the instructional device 532 of the weight handling workstation 500. In a further aspect of this exemplary embodiment, a test taker may complete a portion of the tasks in the strenuous weight handling workstation 500, complete the tasks of the pattern tracing station 600, and then complete the remaining tasks of the weight handling workstation 500.

It is noted that terms like “specifically,” “preferably,” “typically”, and “often” are not utilized herein to limit the scope of the claimed invention or to imply that certain features are critical, essential, or even important to the structure or function of the claimed invention. Rather, these terms are merely intended to highlight alternative or additional features that may or may not be utilized in a particular embodiment of the present invention. It is also noted that terms like “substantially” and “about” are utilized herein to represent the inherent degree of uncertainty that may be attributed to any quantitative comparison, value, measurement, or other representation.

While particular embodiments and aspects of the present invention have been illustrated and described, various other changes and modifications can be made without departing from the spirit and scope of the invention. Moreover, although various inventive aspects have been described, such aspects need not be utilized in combination. It is therefore intended to cover in the appended claims all such changes and modifications that are within the scope of this invention.

What is claimed is:

1. A testing system configured to test a person's performance at manufacturing related tasks, comprising:
at least one simulated workstation, wherein the workstation models a manufacturing related task and comprises,
at least one work piece to which the task is to be conducted;
at least one detector associated with the work piece, the detector operable to detect a manufacturing task performed by a person and configured to generate a signal based upon the performance;
at least one instructional device configured to inform a person of the tasks to be performed on the work piece at the workstation; and
at least one automated electronic scoring mechanism configured to receive the signal from the detector and tabulate a person's performance at the task.

2. A system according to claim 1 wherein the simulated workstations are configured to test a person's performance at bolt insertion and removal, at wire harness connection and disconnection, at welding, at painting, at handling weights of various sizes, or combinations thereof.

3. A system according to claim 1 wherein the instructional device comprises a display monitor, an audio device, an instruction document, or combinations thereof.

4. A system according to claim 1 wherein the testing system further comprises a user control component configured to allow a person to control the instructional device, and comprising a keypad, a mouse, or combinations thereof.

5. A system according to claim 1 wherein the detector comprises an imaging device configured to provide image data representing the work piece, wherein the image data comprises the signal sent to the automated electronic scoring mechanism.

6. A system according to claim 1 wherein the detector is a sensor comprising a switch configured to open or close a circuit upon actuation, a magnetic switch, a motion sensor, a contact switch, relay, proximity switch, position detector, or combinations thereof.

7. A system according to claim 1 further comprising a signal converter operable to translate the detector signal into a usable format for the automated scoring mechanism.

8. A system according to claim 1 wherein the automated electronic scoring mechanism is configured to record the speed and accuracy of a person performing manufacturing tasks.

9. A system according to claim 1 wherein the automated electronic scoring mechanism is operable to randomize the tasks performed at a simulated workstation.

10. A system according to claim 1 wherein the automated electronic scoring mechanism is operable to score a person's performance against at least a sample of all test takers.

11. A system according to claim 1 wherein the automated electronic scoring mechanism is operable to adjust a person's score to correct for malfunctions in the simulated work station.

12. A system according to claim 1 wherein the automated electronic scoring mechanism comprises a microprocessor or computer.

13. A system according to claim 1 wherein the automated electronic scoring mechanism comprises software configured to tabulate the scores of the person's performance.

14. A work evaluation method comprising:
providing at least one simulated workstation configured to inform one or more persons of a manufacturing task to be performed at the simulated workstation, and to automatically score the person's performance at the task;
receiving score data from the simulated workstation on the persons' performance at the manufacturing task;
producing a work profile for each person from the score data;
providing at least one job profile comprising performance criteria required for a specific job; and
ascertaining whether the person's work profile substantially matches the performance criteria of the job profiles.

15. A work evaluation method according to claim 14 further comprising making an offer of employment to those persons whose profiles substantially match the performance criteria.

16. A work evaluation method according to claim 14 further comprising providing a tutorial that demonstrates the proper procedure for performing the manufacturing related tasks.

17. A work evaluation method comprising:
providing a first manufacturing related task to be performed by a person at a simulated workstation;
recording the person's performance of the first task at the simulated workstation via an automated electronic scoring mechanism; and
generating automatically at least one additional task to be performed by the person at the simulated workstation based upon the recorded performance of the first task.

18. A work evaluation method according to claim 17 wherein the recording of the performance further comprises the steps of
receiving signals from a plurality of detectors to record the persons, the detectors being triggered by the person performing the manufacturing related task; and
evaluating the person's performance by comparing the timing and order of the detector signals to an expected timing and order of detector signals.

19. A method according to claim 17 wherein the automatically generating operation comprises:
determining the affected location on the workstation of the person's performance of the first task; and
determining an additional task to be performed at the workstation, such that the affected location does not preclude completion of the additional task.

20. A method according to claim 17 further comprising assigning at least one additional task at another simulated workstation.
